(19) United States
(12) Patent Application Publication
(10) Pub. No.: US 2024/0012611 A1
(43) Pub. Date: Jan. 11, 2024

(54) METHOD AND SYSTEM FOR CONTROLLING SPEECH-CONTROLLED GRAPHICAL OBJECT

(71) Applicant: Speechly Oy, Helsinki (FI)

(72) Inventors: Ari Nykänen, Helsinki (FI); Janne Pylkkönen, Espoo (FI); Hannes Heikinheimo, Helsinki (FI)

(73) Assignee: Speechly Oy, Helsinki (FI)

(21) Appl. No.: 17/858,635

(22) Filed: Jul. 6, 2022

(51) Int. Cl. G06F 3/16; G06F 3/04842; G10L 15/00

(52) U.S. Cl. CPC G06F 3/167; G06F 3/04842; G10L 15/00

(57) ABSTRACT

A method for controlling at least one speech-controlled graphical object. The method includes rendering, on a user interface, the at least one speech-controlled graphical object, each speech-controlled graphical object having at least one parameter associated therewith; selecting a speech-controlled graphical object from amongst the at least one speech-controlled graphical object; configuring, based on the selected speech-controlled graphical object, a speech recognition engine, associated with the user interface, to identify the at least one parameter associated with the selected speech-controlled graphical object, receive a speech signal to control the identified at least one parameter, and generate, based on the speech signal, a corresponding text representation of a speech command; and controlling, based on the speech command, the selected speech-controlled graphical object. Disclosed also is a system for controlling at least one speech-controlled graphical object.

### TECHNICAL FIELD

The present disclosure relates to a method for controlling at least one speech-controlled graphical object. The present disclosure also relates to a system for controlling at least one speech-controlled graphical object.

### BACKGROUND

With the advancement in technology, the global usage of speech recognition technology is increasing day by day due to various applications thereof. In this regard, the speech recognition technology is used in a wide range of industries including, but not limited to, automotive, healthcare, sales, security, electronics, and so forth. Moreover, recent advancements in natural language processing and cloud services particularly have contributed to mass adoption of speech-controlled devices.

Notably, the speech recognition technology is used with user interfaces of various web applications and mobile applications. In this regard, the speech recognition technology is used to control fields associated with the user interface. In an example, a web application comprises a form having multiple fields that are required to be filled using the speech recognition technology. However, the speech recognition technology sometimes lacks accuracy and might fail to receive a speech command accurately in order to fill the form correctly.

Additionally, the speech recognition technology is used in a virtual reality environment (such as a three-dimensional virtual reality). In this regard, the virtual reality environment comprises several objects. However, the conventional speech recognition technology may fail to understand the speech command and associate thereto a corresponding object. Therefore, the conventional speech recognition technology fails to effectively control the desired object amongst several objects.

Therefore, in light of the foregoing discussion, there exists a need to overcome the aforementioned drawbacks associated with the existing speech recognition technology.

### SUMMARY

The present disclosure seeks to provide a method for controlling at least one speech-controlled graphical object. The present disclosure also seeks to provide a system for controlling at least one speech-controlled graphical object. An aim of the present disclosure is to provide a solution that overcomes at least partially the problems encountered in prior art.

In one aspect, an embodiment of the present disclosure provides method for controlling at least one speech-controlled graphical object, the method comprising:
rendering, on a user interface, the at least one speech-controlled graphical object, each speech-controlled graphical object having at least one parameter associated therewith;
selecting a speech-controlled graphical object from amongst the at least one speech-controlled graphical object;
configuring, based on the selected speech-controlled graphical object, a speech recognition engine, associated with the user interface, to
   identify the at least one parameter associated with the selected speech-controlled graphical object,
   receive a speech signal to control the identified at least one parameter, and
   generate, based on the speech signal, a corresponding text representation of a speech command; and
controlling, based on the speech command, the selected speech-controlled graphical object.

In another aspect, an embodiment of the present disclosure provides a system for controlling at least one speech-controlled graphical object, the system comprising:
a user device having a display for rendering a user interface therein, wherein the user interface comprising at least one speech-controlled graphical object, each speech-controlled graphical object having at least one parameter associated therewith;
a processor, associated with the user device, configured to
   select a speech-controlled graphical object from amongst the at least one speech-controlled graphical object;
   configure, based on the selected speech-controlled graphical object, a speech recognition engine, associated with the user interface, to
      identify the at least one parameter associated with the selected speech-controlled graphical object,
      receive a speech signal to control the identified at least one parameter, and
      generate, based on the speech signal, a corresponding text representation of a speech command; and
   controlling, based on the speech command, the selected speech-controlled graphical object.

Embodiments of the present disclosure substantially eliminate or at least partially address the aforementioned problems in the prior art, and enable an improved and efficient method for controlling at least one speech-controlled graphical object. Moreover, the method includes the step of rendering, on a user interface, the at least one speech-controlled graphical object and associating each of the speech-controlled graphical object with at least one parameter. Advantageously, the aforementioned step enables an effective and accurate controlling of the speech-controlled graphical object. Beneficially, the method reduces possibility of errors by employing the speech recognition engine that relates the speech signal to the corresponding text representation of speech command. Furthermore, the speech recognition engine is robust and predictable.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart depicting steps of a method for controlling at least one speech-controlled graphical object, in accordance with an embodiment of the present disclosure;

FIG. 2 is a schematic illustration of a system for controlling at least one speech-controlled graphical object, in accordance with an embodiment of the present disclosure;

FIG. 3 is an exemplary implementation of a system for controlling at least one speech-controlled graphical object, in accordance with an embodiment of the present disclosure;

FIGS. 4A and 4B are another exemplary implementation of a system for controlling at least one speech-controlled graphical object, in accordance with an embodiment of the present disclosure; and

FIG. 5 is a flowchart depicting steps of a method for controlling at least one speech-controlled graphical object, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides method for controlling at least one speech-controlled graphical object, the method comprising:
rendering, on a user interface, the at least one speech-controlled graphical object, each speech-controlled graphical object having at least one parameter associated therewith;
selecting a speech-controlled graphical object from amongst the at least one speech-controlled graphical object;
configuring, based on the selected speech-controlled graphical object, a speech recognition engine, associated with the user interface, to
   identify the at least one parameter associated with the selected speech-controlled graphical object,
   receive a speech signal to control the identified at least one parameter, and
   generate, based on the speech signal, a corresponding text representation of a speech command; and
controlling, based on the speech command, the selected speech-controlled graphical object.

In another aspect, an embodiment of the present disclosure provides a system for controlling at least one speech-controlled graphical object, the system comprising:
a user device having a display for rendering a user interface therein, wherein the user interface comprising at least one speech-controlled graphical object, each speech-controlled graphical object having at least one parameter associated therewith;
a processor, associated with the user device, configured to
   select a speech-controlled graphical object from amongst the at least one speech-controlled graphical object;
   configure, based on the selected speech-controlled graphical object, a speech recognition engine, associated with the user interface, to
      identify the at least one parameter associated with the selected speech-controlled graphical object,
      receive a speech signal to control the identified at least one parameter, and
      generate, based on the speech signal, a corresponding text representation of a speech command; and
   controlling, based on the speech command, the selected speech-controlled graphical object.

The present disclosure provides the aforementioned method and the aforementioned system for controlling at least one speech-controlled graphical object. Beneficially, the aforesaid method and system provide a robust, time-efficient and user-friendly control of the user interface. In this regard, each speech-controlled graphical object, having at least one parameter associated therewith, is efficiently controlled based on a speech input by the user. Moreover, the speech command is interpreted precisely for controlling the speech-controlled graphical object to perform a desired action accordingly.

Pursuant to the embodiments of the present disclosure, the term “user-interface” as used herein refers to a means for controlling either apparatuses or software applications by a user thereof. In other words, the user interface is a space to allow interactions between a human and a user device in order to allow effective operation and control of the user device from the human end. Herein, the term “user” refers to any entity such as a person (i.e., human being) or a virtual program (such as, an autonomous program or a bot) that is associated with a system or operates the user-interface rendered on the display of the system.

Throughout the present disclosure, the term “user device” as used herein refers to an electronic device associated with (or used by) the user that is capable of enabling the user to provide commands. In this regard, the user device includes a display for rendering a user interface therein. Optionally, the user device may include, but not limit to cellular phones, smartphones, personal digital assistants (PDAs), handheld devices, laptop computers, personal computers, tablet computers, desktop computers, extended reality (XR) headsets, XR glasses, televisions, and the like. Moreover, the user device is configured to host one or more application programming interfaces thereon to support and/or enable the operation of an associated system. Furthermore, the user device is intended to be broadly interpreted to include any electronic device that may be used for voice and/or data communication over a wired or wireless communication network. The user device typically has a display on which graphical objects can be rendered.

Optionally, the user-interface of the present disclosure is a speech-controlled user-interface. Optionally, in an example, the user interface may be a multi-dimensional user interface, a data entry form, a professional application, a game, a data dashboard, a mobile site, a virtual reality environment, an augmented reality environment, a metaverse application, and so forth. The term “display” as used herein refers to specialized layer of the system that is configured to render the user-interface for rendering or displaying images when the system is in operation. The display may be provided in devices such as cellular phones, smartphones, personal digital assistants (PDAs), handheld devices, laptop computers, personal computers, tablet computers, desktop computers, extended reality (XR) headsets, XR glasses, televisions, and the like, that are operable to present the text or media to the users. Examples of the display include, but are not limited to, a Liquid Crystal Display (LCD), a Light-Emitting Diode (LED)-based display, an Organic LED (OLED)-based display, a micro OLED-based display, an Active Matrix OLED (AMOLED)-based display, and a Liquid Crystal on Silicon (LCoS)-based display.

The term “at least one speech-controlled graphical object” as used herein refers to one or more entities or graphical elements of the user interface that are used to convey information, and represent actions that are taken by the user using speech-recognition. In this regard, the at least one speech-controlled graphical object is rendered on the user interface. It will be appreciated that the speech-recognition enables an effective control over the at least one speech-controlled graphical objects.

Optionally, the at least one speech-controlled graphical object is selected from any of: a text, a character, an environment, a widget, an icon, an image, an article, an illustration. In this regard, for example, the at least one speech-controlled graphical object may be a virtual object in the environment. Optionally, the environment may be the multi-dimensional environment such as a game world. Optionally, the character may be a virtual character or a part thereof. Optionally, the widget may be the text field such as a name field, an address field, and the like. In an implementation, the user interface may be a website for booking a bus ticket having one or more speech-controlled graphical objects such as the text fields for registering name, address, destination, and so forth.

Moreover, each speech-controlled graphical object is having at least one parameter associated therewith. The term “at least one parameter” as used herein refers to a characteristic associated with the at least one speech-controlled graphical object. In this regard, each speech-controlled graphical object may have various parameters that may be controlled or modified, when in operation.

Optionally, the at least one parameter is selected from any one of: a text field, a shape, a size, a weight, a number, a color, a brightness, a label. Optionally, the shape may be a square, a triangle, a rectangle, a polygon, a circle, and so forth. Optionally, the at least one speech-controlled graphical object may have a combination of parameters associated therewith. In an implementation, the at least one speech-controlled graphical object may be the illustration having the at least one parameter such as the color, the size, the brightness and the label, that is required to be controlled using the speech-recognition. In another implementation, a name field in a web form may have the at least one parameter that may be configured to provoke or “understand” names as an input, thereby reducing the possibility of errors. In another example the user interface is used to control three-dimensional objects (such as in a Computer Aided Design program), wherein each of the three-dimensional object may perform specific actions such as the at least one parameter of the cube may be a size of the cube, or if the at least one graphical object is planar surface then the specific action could be limited to setting color (such as red, blue, and so forth) of the surface. Optionally, at least one parameter may be a weight in milligrams, grams, kilograms, ounces, pounds, tons, and the like, wherein the at least one graphical object is a text field such as a grocery item such as a fruit for example a mango or a banana. Optionally, the at least one parameter is a size for example a cross-section, a volume, and so forth. Additionally, the at least one parameter may be a general parameter used to define a specific graphical object. In this regard, a dimension, a form, a texture, a type, a fabrication material, and so forth.

Furthermore, the method comprises selecting a speech-controlled graphical object from amongst the at least one speech-controlled graphical object. In this regard, the method enables the user interface to select a desired speech-controlled graphical object among the several speech-controlled graphical objects associated with the user-interface. It will be appreciated that selecting the speech-controlled graphical object improves the accuracy of the method by reducing the chances of error during the operation, thereby providing an improved and satisfying user-experience.

Optionally, selecting the speech-controlled graphical object from amongst the at least one speech-controlled graphical object is achieved by using a pointer, a gaze, or a tactile input. Optionally, the gaze enables the user to select the speech-controlled graphical object by focusing the user's eye gaze thereon within a dwell time. Optionally, the tactile input is a computer-pointing technology based upon the sense of touch. It will be appreciated that the tactile input may allow the user, particularly those with visual impairments, an added level of interaction based upon tactile or Braille input. Optionally, the pressing may allocate focus to the at least one speech-controlled graphical object that is required to be filled. Additionally, alternatively, optionally, selecting the speech-controlled graphical object from amongst the at least one speech-controlled graphical object is achieved by using a speech input besides or in combination with other aforementioned multiple modalities. Indeed according to an embodiment user can select at least one speech-controlled graphical object (i.e. an object whose characteristics can be modified using speech or an object which can use speech as an input). The speech-controlled graphical object can be an object whose characteristics are modified with speech (such as in computer aided design (CAD) or it can be a graphical object which further controls external components or equipment (such as home automation or devices).

Furthermore, the method comprises configuring, based on the selected speech-controlled graphical object, a speech recognition engine, associated with the user interface. The term “speech recognition engine” (namely, an automatic speech recognition (ASR), computer speech recognition or speech to text) as used herein refers to a technology that enable the recognition and translation of spoken language into text. In this regard, the speech recognition engine is configured to identify the at least one parameter associated with the selected speech-controlled graphical object.

In an example user interface there can be two or more different speech-controllable graphical objects. For example if a user selects a first graphical object, which has a first type of parameter space (for example the first graphical object is purposed on controlling a temperature in home automation system thus parameters are related to temperature readings, used unit system (Celsius/Fahrenheit/Kelvin), which room the temperature adjustment should be done). In this example a speech recognition engine is configured, based on selecting the first graphical object, to understand numbers, units and room names. “Understanding” refers for example selecting from the speech recognition engine a module specialized for such terminology or limiting generated corresponding text representations to said first parameter space. This way the speech recognition is purpose targeted and will bring more reliable results as speech is associated with the purpose of selected graphical object. In similar manner if a user selects a second graphical object from the user interface, then the speech recognition engine is configured based on that selection. The second graphical object could be for example related to adjusting lights in a house. In this example the speech recognition engine would be configured to have adjusted probability on “lights on” “lights off” type of speech commands. The adjusted probability refers on lowering probability level of accepting speech command based on associated parameter(s).

It will be appreciated that the speech recognition engine is configured to receive the speech signal to control the identified at least one parameter. The term “speech signal” as used herein refers to a human vocal communication using language. Optionally, the speech signal may be a representation of sound, typically using either a changing level of electrical voltage for analog signals, or a series of binary numbers for digital signals. Typically, the speech signals have frequencies in the audio frequency range of roughly 20 to 20,000 Hz, which corresponds to the lower and upper limits of human hearing. Notably, the speech signals may be characterized by parameters such as a bandwidth, a nominal level, a power level in decibels (dB), and a voltage level thereof. Optionally, the speech signals may be synthesized directly, or may originate at a transducer such as a microphone.

Optionally, the speech signal is received via a microphone associated with a user device having a display for rendering the user-interface thereon. The term “microphone” as used herein refers to a specialized component for receiving sound waves as input and converting the received sound waves into electrical energy (or signals) for desired amplification, transmission and recording. Optionally, the method comprises receiving the speech signal via more than one microphone. Optionally, examples of microphones may include dynamic microphones, condenser microphones, ribbon microphones, and the like. In this regard, the microphone is associated with the user device for receiving the speech signal. Moreover, the user device having the display for displaying information, such as for example text or images, when the user device is in operation. Optionally, the microphone receives the speech signal as inputs, such as via the microphone of the user device, and provides text, visual or auditory output, via the display control panel or the audio piece of the user device.

Additionally, the speech recognition engine is configured to generate, based on the speech signal, a corresponding text representation of a speech command. In this regard, the speech recognition engine may use a software program such as a speech-to-text converting module comprising a set of instructions for performing speech recognition and translate spoken languages into the corresponding text. Optionally, the speech-to-text converting module may be typically based on Hidden Markov Model (HMM), deep neural network models, and the like, to convert the voice into text.

Optionally, configuring the speech recognition engine comprises using a language model to specify the speech command associated with the selected speech-controlled graphical object. The term “language model” as used herein refers to an algorithm or a probability distribution over sequences of words. In other words, the language model generates probabilities by training on text corpora in one or many languages. Furthermore the language model can be a list of words or sentences which are accepted or relevant for controlling the selected speech-controlled (controllable) graphical object. Indeed for example each of the speech-controlled graphical objects might be associated with a list of words, which is different depending on the purpose of the speech-controlled graphical object. Typically, the at least one speech controlled graphical objects are associated with the corresponding text representation of speech commands and a corresponding vocabulary may be used to control thereto. As an example, the speech-to-text converting module employ an acoustic modelling algorithm, and, optionally, a pronunciation modelling algorithm for the speech recognition. In another example the speech-to-text module is based end-to-end deep neural network model. Optionally, the speech-to-text converting module follows a supervised learning or unsupervised learning approaches for speech recognition.

Furthermore, the method comprises controlling, based on the speech command, the selected speech-controlled graphical object. In this regard, the speech command is used to control the selected speech-controlled graphical object to perform the desired action. In an implementation, the user interface may have a web form with the text fields of name and address to fill therein. Herein, the first step is to render the web form in the user interface followed by selecting either the name field (a first speech-controlled graphical object) or the address field (a second speech-controlled graphical object). The subsequent step is to configure the speech recognition engine to understand map commands if the address field is pointed. Moreover, the speech signal is received (via the microphone of the user device) and the speech signal is provided to the speech recognition engine that is configured on “a map mode”. Furthermore, as a result the address field is filled in the name field of the web form.

In another implementation, as a first step the user may point to the at least one speech-controlled graphical object such as the cylinder in order to select thereto. Herein, the cylinders may have at least one parameter such as the label, the radius and the height. Moreover, the speech recognition engine may generate the speech command to enable controlling of the at least one speech-controlled graphical object.

The present disclosure also relates to the system as described above. Various embodiments and variants disclosed above apply mutatis mutandis to the system.

The system comprises a processor associated with the user device. Throughout the present disclosure, the term “processor” as used herein refers to hardware, software, firmware or a combination of these. The processing arrangement controls overall operation of the system. In particular, the processing arrangement is coupled to and controls operation of various components of the system and other devices communicably coupled to the aforementioned system. It will be appreciated that the processing arrangement is operable to select a speech-controlled graphical object from amongst the at least one speech-controlled graphical object and configure, based on the selected speech-controlled graphical object, a speech recognition engine, associated with the user interface, as discussed above.

Optionally, the speech recognition engine comprises a language model to identify the at least one parameter associated with the selected speech-controlled graphical object. The speech recognition engine typically comprises also language model to recognize speech commands associated with the at least one parameter associated with the selected speech-controlled graphical object.

Optionally, the speech-controlled graphical object is selected from amongst the at least one speech-controlled graphical object using a pointer, a gaze, a tactile input. Example of the pointer is a mouse or finger in case of touch screen. Benefit of selecting the at least one speech-controlled object is that the object related parameters can be selected after selecting the object.

Optionally, the at least one speech-controlled graphical object is selected from any of: a text, a character, an environment, a widget, an icon, an image, an article, an illustration.

Optionally, the at least one parameter is selected from any one of: a text field, a shape, a size, a weight, a number, a color, a brightness, a label.

Optionally, the user device comprises a microphone for providing a speech signal.

The present disclosure also relates to the computer program product as described above. Various embodiments and variants disclosed above apply mutatis mutandis to the computer program product.

Optionally, the computer program product is implemented as an algorithm, embedded in a software stored in the non-transitory machine-readable data storage medium. The non-transitory machine-readable data storage medium may include, but is not limited to, an electronic storage device, a magnetic storage device, an optical storage device, an electromagnetic storage device, a semiconductor storage device, or any suitable combination of the foregoing. Examples of implementation of the computer-readable medium include, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory.

In one example implementation the user interface is rendered in a device such as a smart phone (or for example user interface of home automation). As the user is using the device the user points with finger a graphical object of interest (at least one speech-controlled graphical object). When this pointing is done the device is configured to open an end point in relation to speech recognition engine to said graphical object. The speech recognition engine is then provided with a parameter space from associated with the graphical object. The provided parameter space is used to configure the speech recognition engine. The speech recognition engine runs typically as a cloud service (but can be also local in the device depending on setup). Now, since the speech recognition engine is configured (tuned) for identified purpose, probability of understanding the speech command is higher than using a speech recognition engine which has not limitation on parameter space. Speech recognition engine typically forms a text representation of the speech command. The text representation is provided to a software running in the device to control the graphical object (or to provide data to device or system controlled via the graphical object). Indeed the controlling the selected speech-controlled graphical object can refer to controlling devices, items, data structures, system which the selected speech-controlled graphical object is associated with. This is beneficial in case of using speech controlling via a user interface having access to set of different external devices via the user interface and external device associated icons (graphical objects) on the user interface.

### DETAILED DESCRIPTION OF THE DRAWINGS

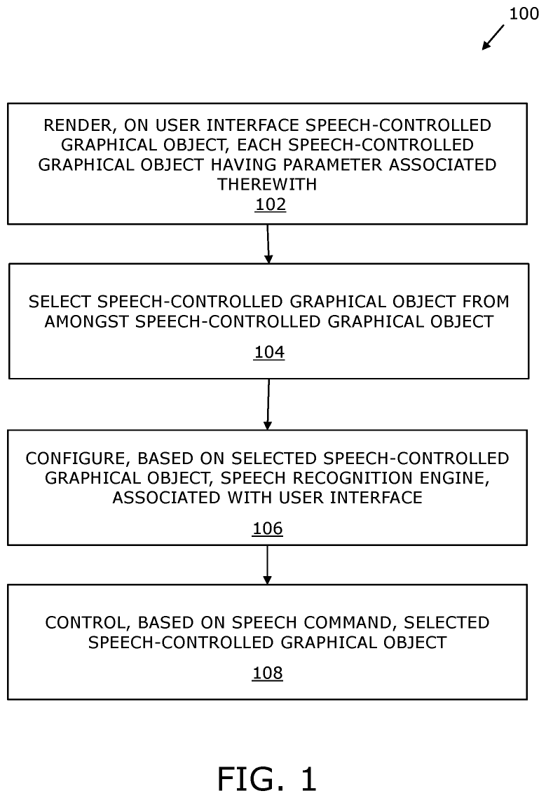

Referring to FIG. 1, illustrated is a flowchart 100 depicting steps of a method for controlling at least one speech-controlled graphical object, in accordance with an embodiment of the present disclosure. At step 102, the at least one speech-controlled graphical object is rendered on a user interface, each speech-controlled graphical object having at least one parameter associated therewith. At step 104, a speech-controlled graphical object is selected from amongst the at least one speech-controlled graphical object. At step 106, a speech recognition engine, associated with the user interface, is configured based on the selected speech-controlled graphical object, to identify the at least one parameter associated with the selected speech-controlled graphical object, receive a speech signal to control the identified at least one parameter, and generate, based on the speech signal, a corresponding text representation of a speech command. At step 108, the selected speech-controlled graphical object is controlled based on the speech command.

The steps 102, 104, 106 and 108 are only illustrative and other alternatives can also be provided where one or more steps are added, one or more steps are removed, or one or more steps are provided in a different sequence without departing from the scope of the claims herein.

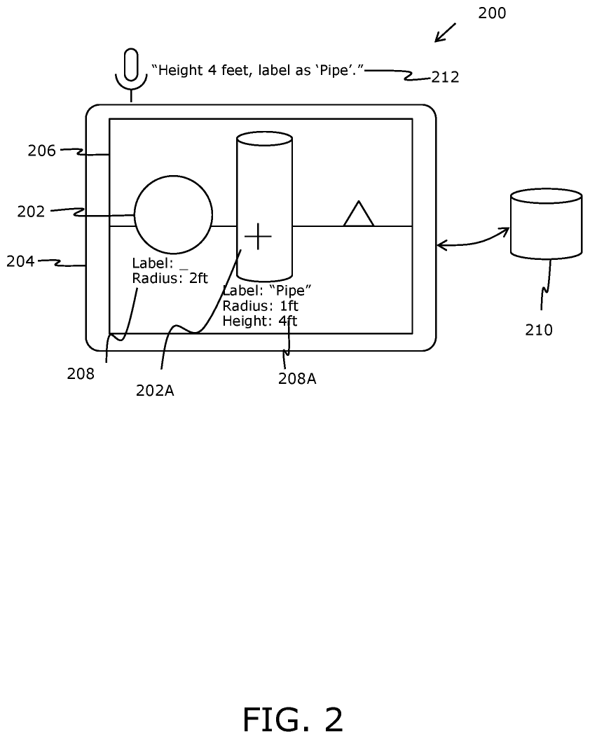

Referring to FIG. 2, illustrated is a schematic illustration of a system 200 for controlling at least one speech-controlled graphical object 202, in accordance with an embodiment of the present disclosure. As shown, the system 200 comprises a user device 204 having a display for rendering a user interface 206 therein, wherein the user interface 206 comprising at least one speech-controlled graphical object 202 (a circle) and 202A (a pipe) in this example, each speech-controlled graphical object 202, 202A having at least one parameter 208, 208A associated therewith. Moreover, the system 200 comprises a processor (not shown), associated with the user device 204, configured to select a speech-controlled graphical object 202A from amongst the at least one speech-controlled graphical object 202 or 202A, configure, based on the selected speech-controlled graphical object 202A, a speech recognition engine 210, associated with the user interface 206, to identify the at least one parameter 208A associated with the selected speech-controlled graphical object 202A, receive a speech signal (not shown) to control the identified at least one parameter 208A, and generate, based on the speech signal, a corresponding text representation of a speech command 212. Furthermore, the system 200 comprises controlling, based on the speech command 212, the selected speech-controlled graphical object 202A as in this example the selected speech-controlled graphical object was “pipe” 202A.

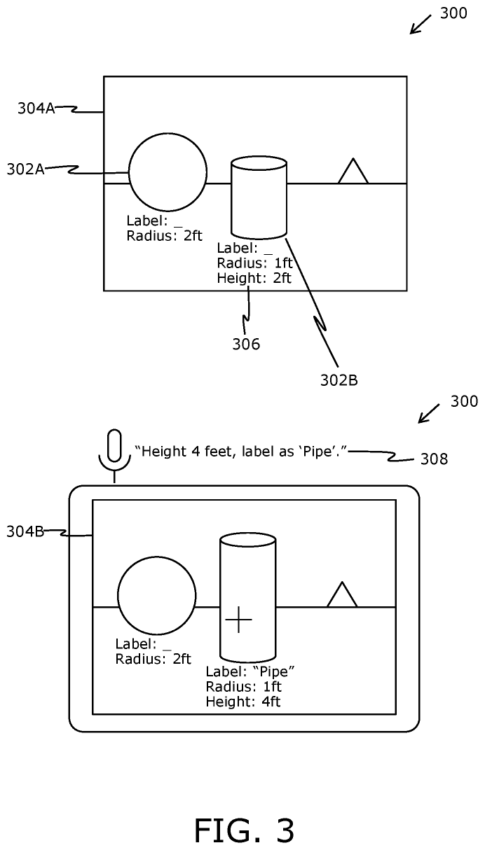

Referring to FIG. 3, illustrated is an exemplary implementation of a system 300 for controlling at least one speech-controlled graphical object 302A or 302B, in accordance with an embodiment of the present disclosure. As shown, a user interface 304A comprising two speech-controlled graphical objects 302A and 302B. Moreover, the speech-controlled graphical object 302A having at least one parameter 306 such as a label, and a radius associated therewith. Furthermore, the speech-controlled graphical object 302B having at least one parameter 306 such as a label, a radius, and a height associated therewith. It will be appreciated that the system 300 comprises a processor (not shown), associated with a user device (not shown), configured to select a speech-controlled graphical object 302B from amongst the at least one speech-controlled graphical object 302A and 302B, configure, based on the selected speech-controlled graphical object 302B, a speech recognition engine (not shown), associated with the user interface 304A, to identify the at least one parameter 306 such as the height associated with the selected speech-controlled graphical object 302B, receive a speech signal (not shown) to control the identified at least one parameter 306, and generate, based on the speech signal, a corresponding text representation of a speech command 308. In an example, the speech command is “height 4 feet, label as pipe”. Furthermore, as shown in the user interface 304B, the system 300 comprises controlling, based on the speech command 308, the selected speech-controlled graphical object 302B.

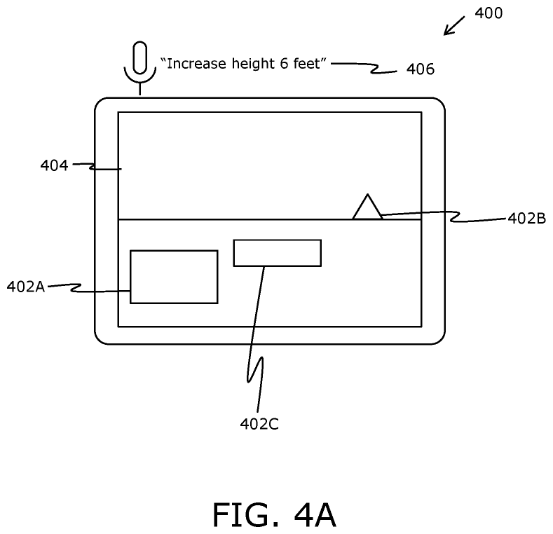

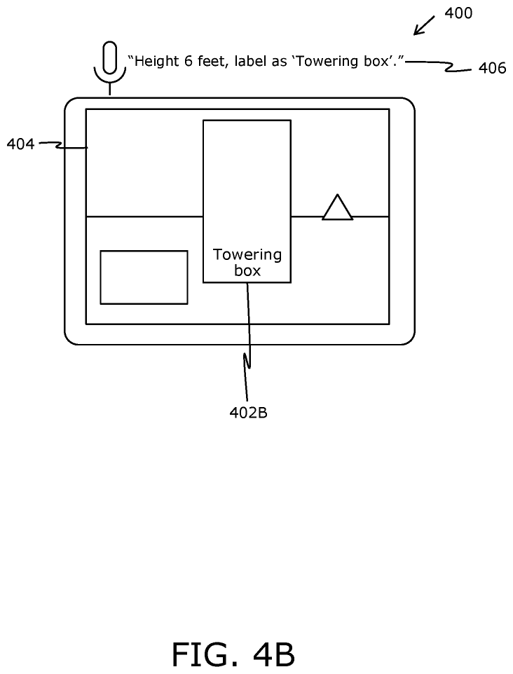

Referring to FIGS. 4A and 4B illustrated are another exemplary implementation of a system 400 for controlling at least one speech-controlled graphical object 402, in accordance with an embodiment of the present disclosure. As shown in FIG. 4A, the system 400 comprises a user interface 404 comprising a plurality of speech-controlled graphical objects 402A, 402B and 402C. Moreover, the system 400 comprises a processor (not shown) configured to select (based on user selection) the speech-controlled graphical object 402B from amongst the at least one speech-controlled graphical object 402A, 402B and 402C. Furthermore, a speech recognition (not shown) is used to generate a speech command 406 “Increase height six feet”. As shown in FIG. 4B, the processor is configured to increase a height of the speech-controlled graphical object 402B to six feet using the speech recognition engine.

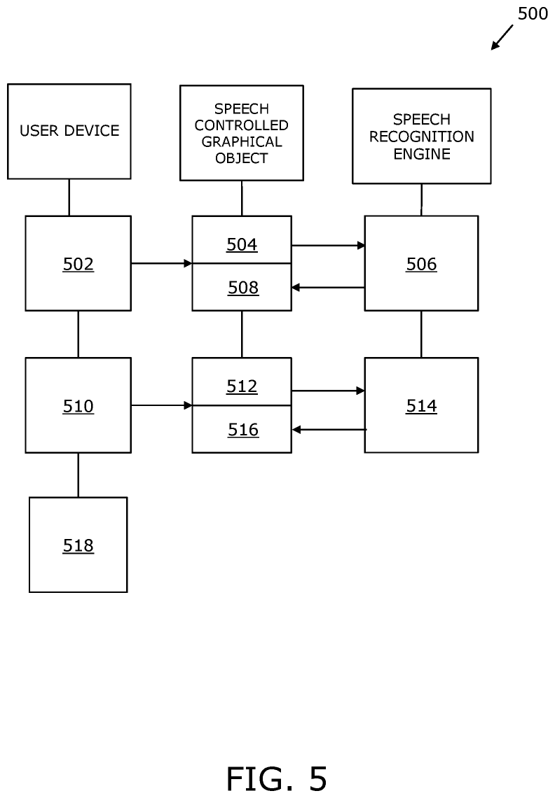

Referring to FIG. 5 illustrated is a flowchart 500 depicting steps of a method for controlling at least one speech-controlled graphical object, in accordance with an embodiment of the present disclosure. As shown, a user device, having a display for rendering a user-interface thereon, and a speech-recognition engine collectively control a speech-controlled graphical object. At step 502, a processor associated with a user device is configured to select (based typically on user input) a speech-controlled graphical object from amongst the at least one speech-controlled graphical object, wherein each speech-controlled graphical object having at least one parameter associated therewith. It will be appreciated that the selection of the speech-controlled graphical object from amongst the at least one speech-controlled graphical object is achieved using a pointer, a gaze, a tactile input from the user. At step 504, the selected speech-controlled graphical object from amongst the at least one speech-controlled graphical object is activated (by means of a visual cue for example) for a desired control by the user. At step 506, the speech recognition engine, associated with the user device, is configured based on the selected speech-controlled graphical object to perform desired control thereof by the user. At step 508, an endpoint ID (identification) of the selected speech-controlled graphical object is stored. The endpoint ID can be understood as an “address” (or pointer to) of the configured speech recognition engine for the selected speech-controlled graphical object. At step 510, a speech signal is received from the user via a microphone associated with the user device. At step 512, the speech signal is provided to the speech recognition engine, wherein the speech signal is associated with the selected speech-controlled graphical object having a corresponding endpoint ID. At step 514, the configured (at step 505) speech recognition engine is used to recognize the speech signal. This way the speech recognition signal can identify the at least one parameter, associated with the selected speech-controlled graphical object, and generate, based on the speech signal, a corresponding text representation of a speech command. At step 516, based on the speech command, the selected speech-controlled graphical object is controlled to modify the identified at least one parameter thereof. At step 518, a desired change in the selected speech-controlled graphical object is obtained on the user interface of the user device. It will be appreciated that in some embodiments, the endpoint ID associated with the selected speech-controlled graphical object is neither stored at the step 508 nor provided to the speech recognition engine at step 512.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for controlling a parameter of at least one speech-controlled graphical object-, the method comprising:
rendering, on a user interface, the at least one speech-controlled graphical object, the at least one speech-controlled graphical object having at least one parameter associated therewith;
selecting a speech-controlled graphical object from among the at least one speech-controlled graphical object;
identifying a parameter associated with the selected speech-controlled graphical object;
configuring, based on the identified parameter, a speech recognition engine associated with the user interface, by:
selecting a language model of the speech recognition engine that is specific to the identified parameter, the selected language model configured to generate one or more speech commands that are specific to, and can be used to control the identified parameter of the speech-control graphical object;
detecting a speech signal and inputting the speech signal to the selected language model of the speech recognition engine;
identifying a speech command from the selected language model that corresponds to the detected speech signal;
generating, based on the speech signal, a corresponding text representation of the identified speech command; and
controlling the parameter of the selected speech-controlled graphical object, based on the corresponding text representation of the speech command.

2. The method according to claim 1, wherein configuring the speech recognition engine further comprises selecting a language model that is pre-configured to generate only speech commands that control the identified parameter of the selected speech-controlled graphical object.

3. The method according to claim 1, wherein selecting the speech-controlled graphical object is selected from the at least one speech-controlled graphical object on the graphical user interface using one or more of a pointer, a gaze or a tactile input.

4. The method according to claim 1, wherein the at least one speech-controlled graphical object comprises one or more of a text, a character, an environment, a widget, an icon, an image, an article, an illustration presented on the graphical user interface.

5. The method according to claim 1, wherein the at least one parameter comprises one or more of a text field, a shape, a size, a weight, a number, a color, a brightness, or a label of the speech-controlled graphical object.

6. The method according to claim 1, wherein the speech signal is received via a microphone associated with the device.

7. A system for controlling a parameter of at least one speech-controlled graphical object-, the system comprising:
a user device having a display for rendering a user interface therein, wherein the user interface comprises the at least one speech-controlled graphical object, the at least one speech-controlled graphical object having at least one parameter associated therewith; and
a processor, associated with the user device, the processor being configured to:
detect a selection of a speech-controlled graphical object from the at least one speech-controlled graphical object;
identify a parameter associated with the selected speech-controlled graphical object;
configure, based on the identified parameter, a speech recognition engine associated with the user interface by
selecting a language model of the speech recognition engine that is specific to the identified parameter, the selected language model comprising one or more speech commands that are specific to, and can be used to control the identified parameter of the speech-control graphical object;
receiving a speech signal and inputting the speech signal to the selected language model of the speech recognition engine;
identifying a speech command from the selected language model that corresponds to the speech signal;
generating, based on the speech signal, a corresponding text representation of the identified speech command; and
controlling the parameter of the selected speech-controlled graphical object, based on the corresponding text representation of the speech command.

8. The system according to claim 7, wherein the selected language model is configured to only generate speech commands that control the identified parameter of the selected speech-controlled graphical object.

9. The system according to claim 7, wherein the speech-controlled graphical object is selected from the at least one speech-controlled graphical object on the graphical user interface using one or more of a pointer, a gaze or a tactile input.

10. The system according to claim 7, wherein the at least one speech-controlled graphical object comprises one or more of a text, a character, an environment, a widget, an icon, an image, an article, an illustration.

11. The system according to claim 7, wherein the at least one parameter comprises one or more of a text field, a shape, a size, a weight, a number, a color, a brightness, or a label of the at least one speech-controlled graphical object.

12. The system according to claim 7, wherein the user device comprises a microphone for detecting the speech signal.

13. A computer program product comprising a non-transitory computer-readable storage medium having computer-readable instructions stored thereon, the computer-readable instructions being executable by a processor to control a parameter of at least one speech controlled graphical object by:
rendering, on a user interface, the at least one speech-controlled graphical object, the at least one speech-controlled graphical object having at least one parameter associated therewith;
selecting a speech-controlled graphical object from among the at least one speech-controlled graphical object;
identifying a parameter associated with the selected speech-controlled graphical object;
configuring, based on the identified parameter, a speech recognition engine associated with the user interface, by:
selecting a language model of the speech recognition engine that is specific to the identified parameter, the selected language model configured to generate one or more speech commands that are specific to, and can be used to control the identified parameter of the speech-control graphical object;
detecting a speech signal and inputting the speech signal to the selected language model of the speech recognition engine;
identifying a speech command from the selected language model that corresponds to the detected speech signal;
generating, based on the speech signal, a corresponding text representation of the identified speech command; and
controlling the parameter of the selected speech-controlled graphical object based on the corresponding text representation of the speech command.

14. The computer program product according to claim 13, wherein the selected language model is configured to only generate speech commands that control the identified parameter of the selected speech-controlled graphical object.
